(19) United States
(12) Patent Application Publication
(10) Pub. No.: US 2008/0027739 A1
(43) Pub. Date: Jan. 31, 2008

(54) Methods and apparatus for management and procurement of hazardous materials

(76) Inventors: Timothy L. Dore, Wilsonville, OR (US); Mark L. Wysong, Lake Oswego, OR (US); Jeffery R. Thompson, Vancouver, WA (US); Steven G. Shubin, Woodburn, OR (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 11/493,911

(22) Filed: Jul. 25, 2006

(51) Int. Cl. G06Q 10/00

(52) U.S. Cl. 705/1

(57) ABSTRACT

Embodiments of the present invention provide methods and apparatus for management and procurement of hazardous materials. Other embodiments may be described and claimed.

### TECHNICAL FIELD

Embodiments of the present invention relate to the field of materials management, and more particularly, to methods and apparatus for management and procurement of hazardous materials.

### BACKGROUND

Many companies have potentially hazardous materials (PHM) in their various inventories for various uses including, but not limited to, the development, manufacturing and distribution of their products. Such companies include, but are not limited to, semiconductor, electronic, automotive, and refining companies. Additionally, many companies may have duplicate types of PHM for similar uses. For example, companies may have numerous types of adhesives, cleaners, disinfectants, etc., many of which are potentially hazardous due to their toxicity levels.

While many companies have general procurement departments for purchasing most PHM for use at the company, “smaller” purchases at individual company sites are often made. Such purchases are generally beneath the procurement department's radar. Thus, as much as 80-95 percent of many companies' materials, especially PHM, may be purchased indirectly. Additionally, many companies may have numerous PHM for the same purpose and out of the procurement department's control, especially in light of the “smaller” purchases. This may result in high dollar inventory, as well as highly toxic products to which a company may not wish for its employees to be exposed. Also, many of the PHM may be obtained from multiple suppliers.

### BRIEF DESCRIPTION OF THE DRAWINGS

Embodiments of the present invention will be readily understood by the following detailed description in conjunction with the accompanying drawings. To facilitate this description, like reference numerals designate like structural elements. Embodiments of the invention are illustrated by way of example and not by way of limitation in the figures of the accompanying drawings.

FIG. 1 schematically illustrates an exemplary embodiment of a computer network that may be utilized within an enterprise that may be comprised of one or sites, in accordance with various embodiments of the present invention;

FIG. 2 schematically illustrates an exemplary embodiment of a server that may be utilized within an enterprise that may be comprised of one or sites, in accordance with various embodiments of the present invention;

FIG. 3 is a flowchart illustrating a process for managing and procuring materials, in accordance with various embodiments of the present invention; and

FIGS. 4-8 illustrate exemplary scattergrams providing results from the process of FIG. 3, in accordance with various embodiments of the present invention.

### DETAILED DESCRIPTION OF EMBODIMENTS OF THE INVENTION

In the following detailed description, reference is made to the accompanying drawings which form a part hereof wherein like numerals designate like parts throughout, and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Various operations may be described as multiple discrete operations in turn, in a manner that may be helpful in understanding embodiments of the present invention; however, the order of description should not be construed to imply that these operations are order dependent.

The description may use perspective-based descriptions such as up/down, back/front, and top/bottom. Such descriptions are merely used to facilitate the discussion and are not intended to restrict the application of embodiments of the present invention.

For the purposes of the present invention, the phrase “A/B” means A or B. For the purposes of the present invention, the phrase “A and/or B” means “(A), (B), or (A and B)”. For the purposes of the present invention, the phrase “at least one of A, B, and C” means “(A), (B), (C), (A and B), (A and C), (B and C), or (A, B and C)”. For the purposes of the present invention, the phrase “(A)B” means “(B) or (AB)” that is, A is an optional element.

The description may use the phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

Embodiments of the present invention provide methods and apparatus for management and procurement of potentially hazardous materials (PHM).

Various embodiments of the present invention will be described herein with respect to management and procurement of PHM for clarity and simplicity. However, those skilled in the art will understand that the present invention may be applicable for the management and procurement of other types of materials.

The term PHM as used herein refers to a broad range of materials that may raise health, safety and/or environmental issues, including in particular those, which usage requires the maintenance of corresponding material safety data sheets (MSDS). Examples of such materials include but are not limited to the materials regulated by e.g. the Environmental Protection Agency of U.S. Government.

An MSDS of a PHM generally specifies the constituents (chemical make-up), first-aid procedures, special handling, storage, fire fighting procedures of the PHM. Not only the special handling and storage procedures have to be followed, the MSDS data must be updated and kept current.

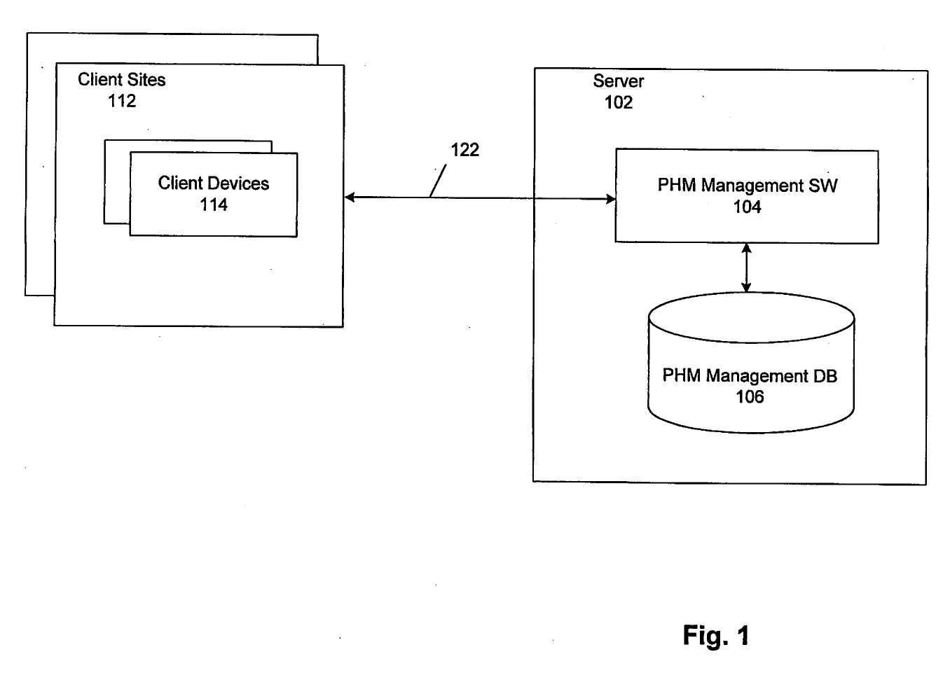

Referring now to FIG. 1, an overview of the present invention, in accordance with various embodiments, may be described. As illustrated, for the embodiments, server 102 is endowed with PHM Management Software 104, which is adapted with functions to provide guidance to client sites. In particular, as will be described in more detail below, PHM Management Software 104 is adapted to provide client sites 112 with summary data relating to PHM management and procurement issues.

For the various embodiments, server 102 is also provided with PHM database 106 having data of the clients. In alternate embodiments, PHM database 106 may be remotely disposed away from server 102 instead.

In various embodiments, PHM Management Software 104 presents the summary data in graphical form on client devices 114. In particular, for the various embodiments, PHM Management Software 104 presents the graphical summaries in the form of web pages. That is, server 102 is further endowed with a web server and various communication interfaces, whereas client devices are endowed with a browser and corresponding communication devices.

In other embodiments, the summary data may be presented in other formats, e.g. as an attachment to electronic communications, as printed mailings, and so forth.

For the various embodiments, client devices 114 are communicatively coupled to servers 102 via network connections 122 over a number of private and/or public networks, including, but not limited to, the Internet. The communications between client devices 114 and server 102 may be conducted in accordance with one of a number of messaging protocols, including but are not limited to, e.g., the HTTP protocol (HTTP=Hypertext Transmission Protocol).

Except for PHM Management Software 104, PHM Database 106, server 102 and client devices 114 represent a broad range of such elements known in the art, or to be designed (as long as they are consistent with the teachings of the present invention). Accordingly, except for PHM Management Software 104, and an example of server 102, PHM Database 106, client devices 114 and coupling 122 will not be further described.

While for ease of understanding, server 102 is “singularly” illustrated, in various embodiments, server 102 may be a single computing device, a cluster of tightly coupled computing devices, or networked computing devices.

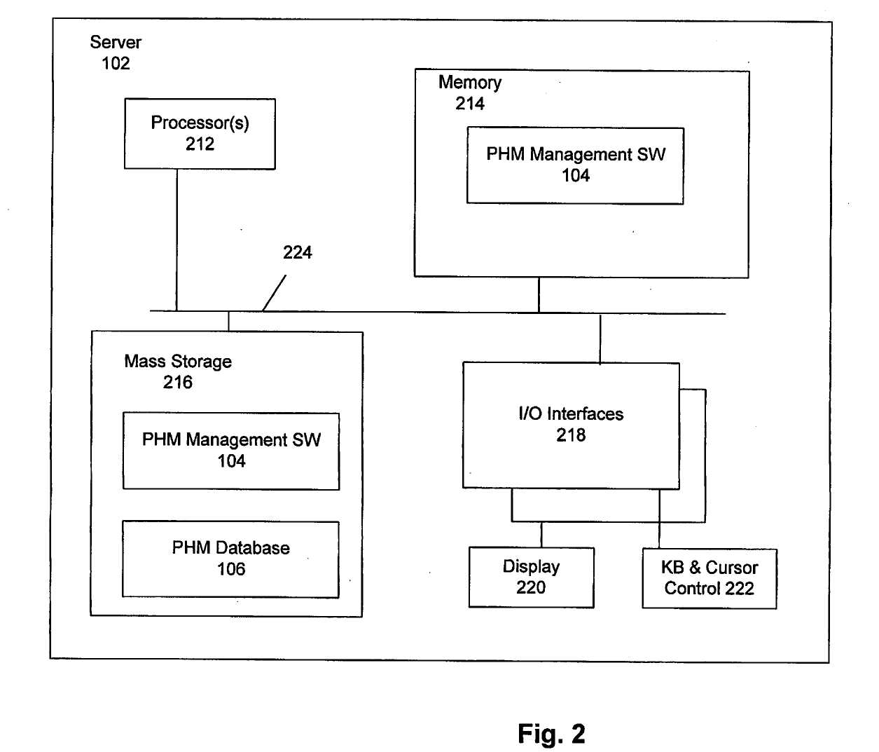

FIG. 2 illustrates an example implementation of server 102 of FIG. 1, in accordance with various embodiments of the present invention. As illustrated, server 102 includes digital computing processor 212, memory 214 coupled to each other via bus 224. Further, device 212 includes mass storage device 216, I/O interfaces 218, and a number of I/O devices coupled to each other and the earlier described elements as shown. Memory 214 and mass storage device 216 include in particular, a transient and a persistent copy of PHM Management Software 104 respectively. Mass storage device 216 further includes PHM database 106. The I/O devices include in particular, display 220 and keyboard/cursor control 222.

In various embodiments, processor 212 may be any one of a number of microprocessors known in the art, or to be designed (as long as they are consistent with the teachings of the present invention), including but are not limited to, the processors available from Intel Corp., of Santa Clara, Calif.

Memory 214 may likewise be any one of a number of volatile storage known in the art or to be designed (as long as they are consistent with the teachings of the present invention), including but are not limited to, the volatile storage available from Kingston Technology of Fountain Valley, Calif. Mass storage device 216 may likewise be any one of a number of non-volatile storage known in the art or to be designed (as long as they are consistent with the teachings of the present invention), including but are not limited to, the non-volatile disk storage available from Seagate of City, Calif.

In various embodiments, I/O interfaces 218 include a communication interface for coupling server 102 to client devices 114. The communication interface may be a wire based or wireless interface, coupling server 102 to devices 114 via a wired/wireless local/wide area network. An example of a suitable wired network interface includes but is not limited to an Ethernet interface, and an example of a suitable wireless network interface includes but is not limited to an IEEE 802.11b (working group) network interface.

Except for PHM Management Software 104 (described further herein), and the manner these elements are employed, each of these elements represents a broad range of the corresponding element known in the art or to be designed, consistent with the teachings of the present invention. The elements perform their conventional functions, i.e. processing, storage, reading, displaying, and so forth.

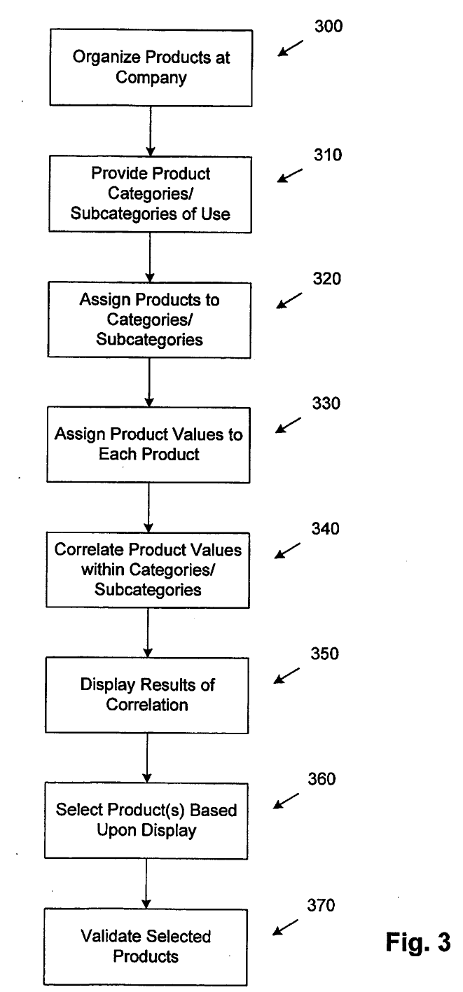

Referring to FIG. 3, in accordance with various embodiments of the present invention, PHM Management Software 104 may be further described. At block 300, PHM at a company are generally organized based upon the company's Material Safety Data Sheets from the company's PHM Database 106. This preferably includes PHM from all sites for the company. Thus, there may be a central, single PHM Database for the company, or there may be multiple PHM Databases for the various company sites. The PHM are organized as individual products available from one or more suppliers.

In accordance with various embodiments of the present invention, product categories of use are provided for the various products at block 310. An example of a first category may be adhesives, while a second category may be cleaners. Each category of use may be further defined and divided into subcategories if desired. For example, the exemplary adhesive category may be divided into subcategories of, for example, glue, thread locker, contact cement, wood adhesive, water based adhesive, etc. At block 320, the products from the database are provided to the product use categories and assigned to the categories and/or subcategories based upon each product's use. Each product may be assigned to one or more categories of use, and if desired, one or more subcategories of use.

At least first and second values are assigned to each product at block 330, either after or prior to assigning the products to a product category of use, in accordance with various embodiments of the present invention. A first value assigned to a product is based upon a first criterion, while a second value is based upon a second criterion. In accordance with various embodiments of the present invention, a first criterion is based upon a level of toxicity and/or environmental effect, while a second criterion is based upon a price or cost for the product. For example, the second criterion may be based upon unit cost or a total price.

In accordance with various embodiments of the present invention, the level of toxicity for products is generally based upon cancer, reproductive and other health risks. One or more data sources are used to provide the level of toxicity. Examples include the International Agency for Research on Cancer (IARC), California Proposition 65, National Toxicology Program (NTP), Hazardous Materials Identification System (HMIS), and the European Union Annex List. Generally, in accordance with various embodiments of the present invention, a point system is provided for the toxicity ranking, wherein higher points mean that a particular product is more toxic. Additionally one or more data sources are utilized to quantify the environmental effect. Examples include Clean Air Act—Hazardous Air Pollutants (CAA HAPS), Clean Air Act—Ozone Depleting Substances (CAA ODS), Resource Conservation and Recovery Act—Hazardous Waste (RCRA), and European Union Annex List. Generally, in accordance with various embodiments of the present invention, a point system is provided for environmental effect ranking, wherein higher points mean that a particular product has a more adverse environmental effect.

In accordance with various embodiments of the present invention, the first and second values for the products are correlated within a selected product category at block 340 to provide summary data. At block 350, the results of the correlation may be presented by displaying the summary data on a display and/or printing by a printer in the form of some sort of ranking, table, chart, graph, etc. The summary data may be presented in any other suitable manner previously described for presenting the summary data.

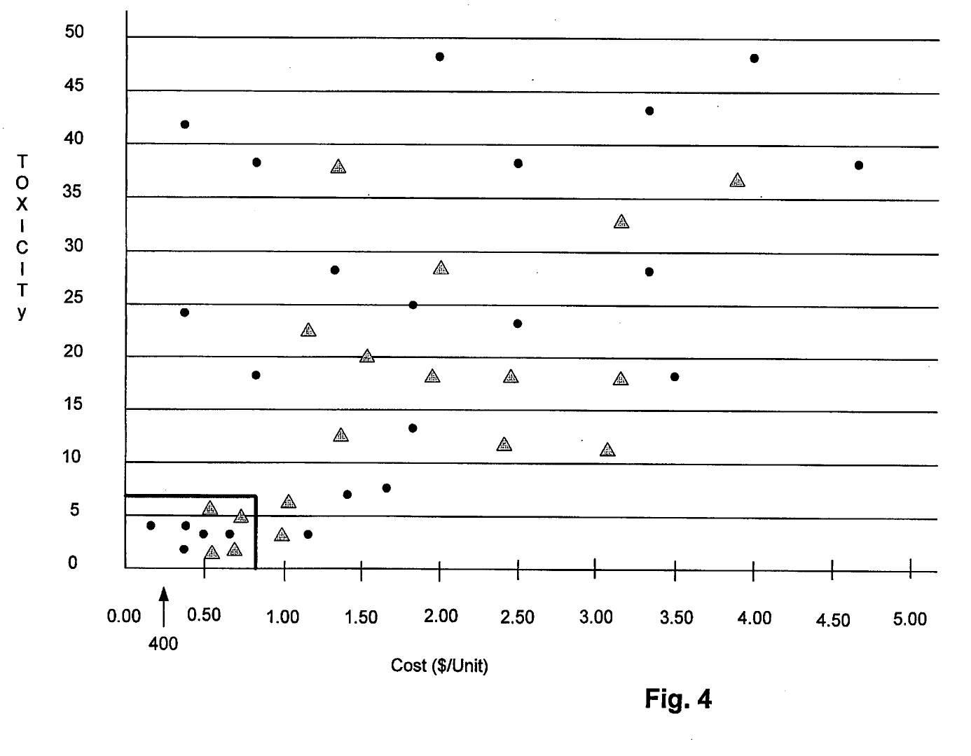

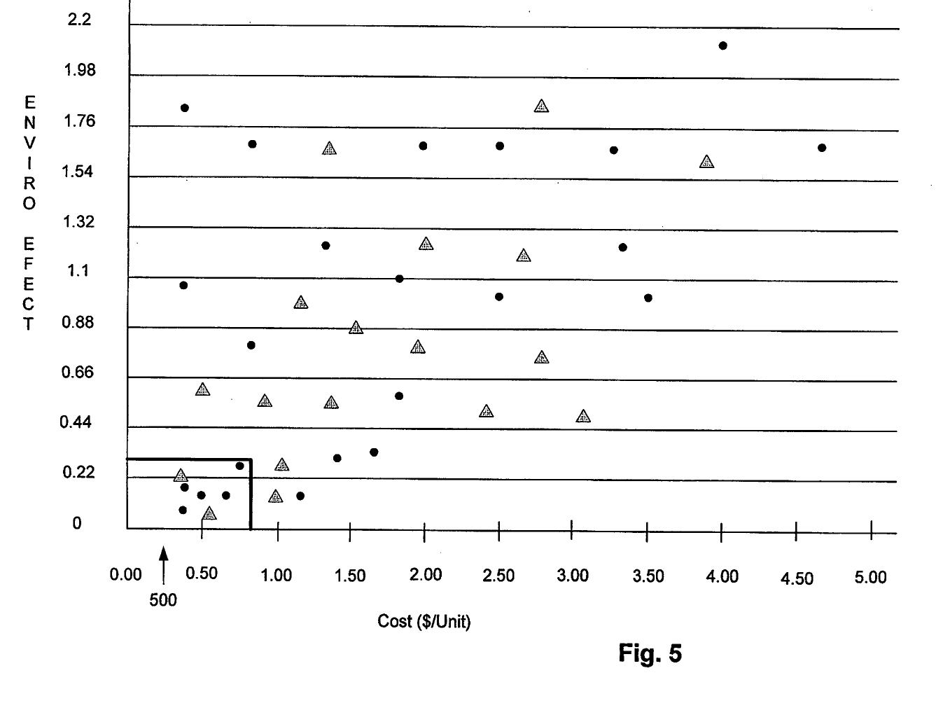

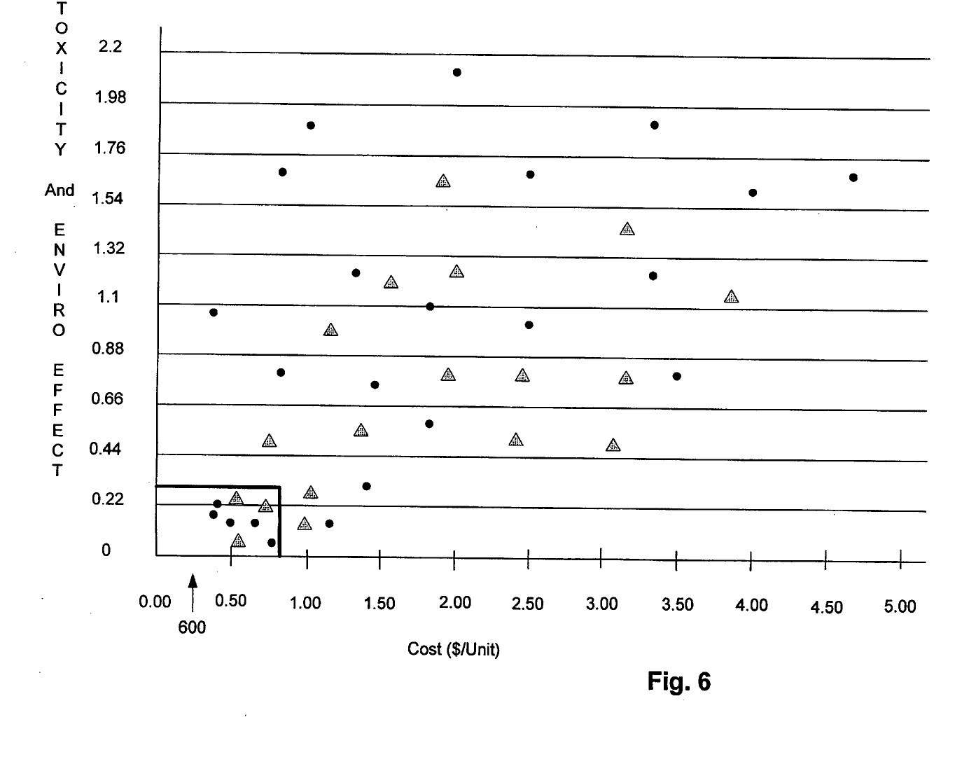

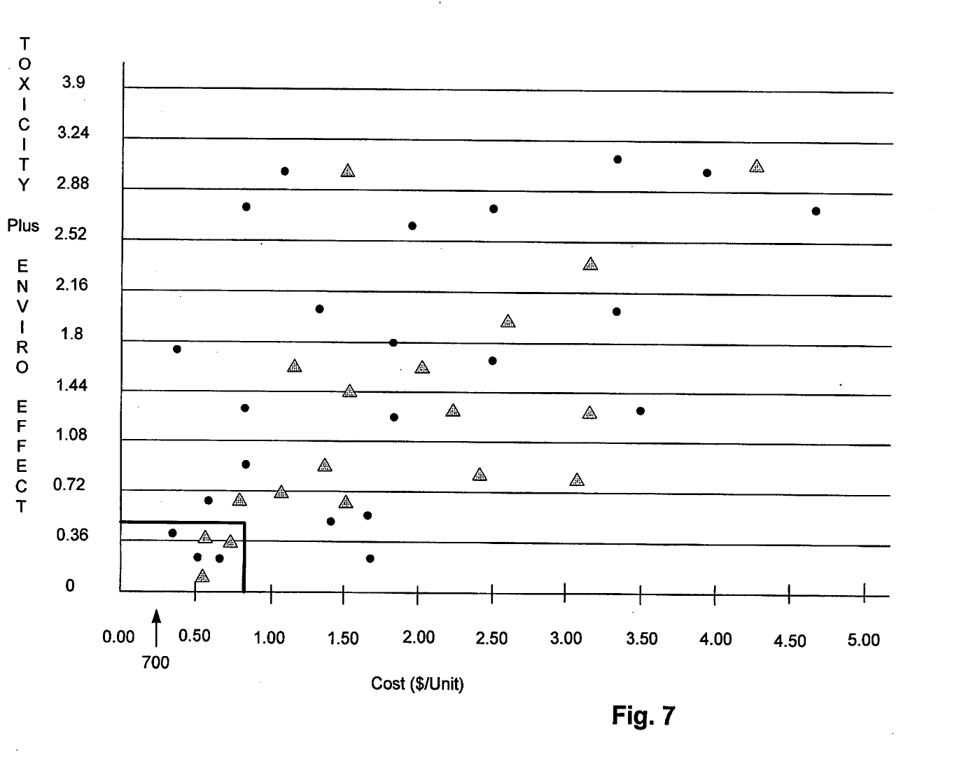

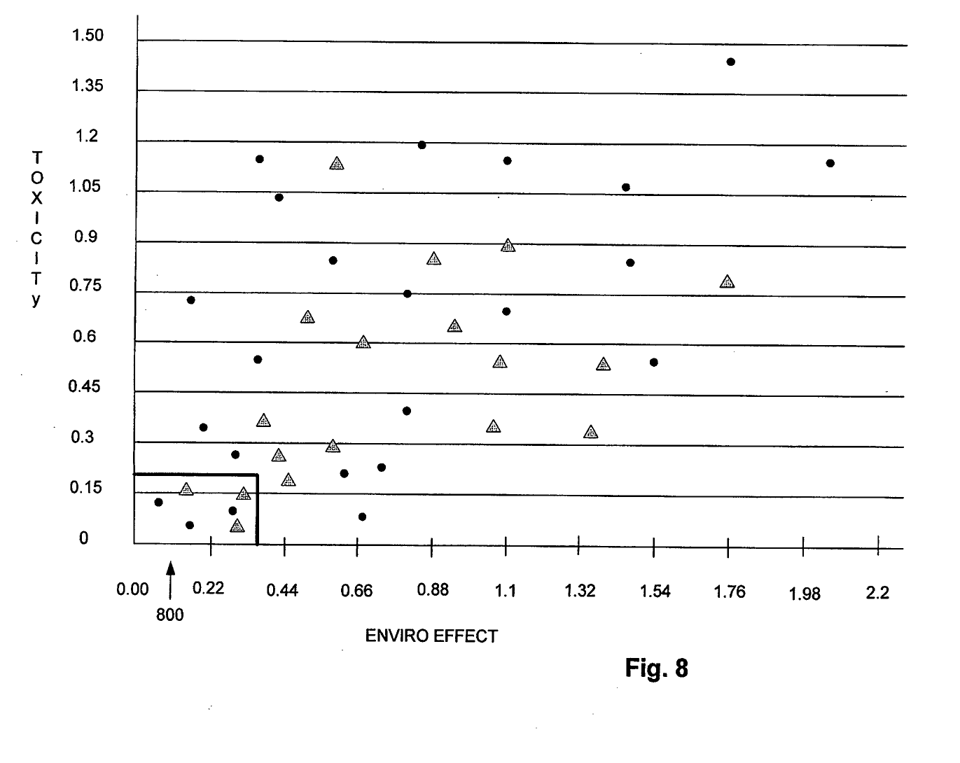

As an example for organizing and presenting the summary data, with reference to FIG. 4, a scattergram is illustrated based upon correlation of product values for products within a product category. As may be seen, a toxic score range of values are plotted along the vertical access of the scattergram, while a range of unit cost values are plotted along the horizontal access of the scattergram. If desired, each product's representation on the scattergram may be shaped to correspond to its availability from a particular company. For example, in the scattergram illustrated in FIG. 4, a triangle for a product represents that the product is available from Supplier A, while the circular points of the products represents that those products are available from other suppliers, or, for example, a second particular Supplier B. In a similar fashion and as examples, FIG. 5 presents an exemplary environmental effect score on the vertical axis and unit cost on the horizontal axis; FIG. 6 presents an exemplary toxic score and a corresponding exemplary environmental effect score on the vertical axis, and unit cost on the horizontal axis; FIG. 7 presents an exemplary toxic score added to a corresponding exemplary environmental effect score on the vertical axis and unit cost on the horizontal axis; and FIG. 8 presents an exemplary toxic score on the vertical axis and an exemplary environmental effect score on the horizontal axis. FIGS. 4-8 are merely illustrative examples and do not have any intended specific relationship or correlation between or among the Figures.

Upon analyzing results of the correlation, in accordance with various embodiments of the present invention, products for a particular product category are selected at block 360 for a company's inventory for the particular product. For example, products may be selected from a target area 400 that is the lower left hand corner within a scattergram as illustrated in FIG. 4. This corner of the scattergram represents lower toxicity scores and lower cost. Accordingly, by selecting products from this region of the scattergram, a company is paying less for the products and is obtaining products having a lower toxicity within the particular product category. In a similar fashion, FIGS. 5-8 may be used to select products using target areas 500, 600, 700 and 800 based upon environmental effects and/or toxicity and/or cost. Target areas from multiple scattergrams may be used to select products if desired.

A third criterion within product selection decision making may include attempting to select products from a single supplier in accordance with various embodiments of the present invention. This may help consolidate purchasing for a company's inventory. Also, selecting products from a single supplier may also be used as a criterion in place of price or toxicity level if desired. Thus, consideration may also be given to products within the scattergram example of FIG. 4 based upon the shape of data points, which represent the supplier of a particular product.

Product selection, in accordance with various embodiments of the present invention, may be done manually by reviewing results of the correlating of products within a category or subcategory by viewing, for example, a scattergram such as illustrated in FIG. 4. Additionally, software may be provided that allows for various selection criteria to be applied to automatically select products based upon results of the correlation.

Once products have been selected for the various product use categories and, any subcategories, a validation process may be applied at block 370, in accordance with various embodiments of the present invention, if desired. In such a validation process, a company may evaluate the various product or products within a category or subcategory in order to determine its effectiveness. For example, a particular cleaner selected with a low toxicity and/or low cost, or whatever the criteria may be, may be evaluated for its effectiveness over a period of time. If for some reason the particular cleaner does not prove to be satisfactorily effective, a different product, even though it may be more toxic and/or more expensive, may be selected to replace the ineffective cleaner. Such validation may generally take place with the employees of the company that use the various products. For example, products within the maintenance, repair and operation organization or department of a company (MRO) should be evaluated by people within the MRO organization or department of the company.

In accordance with various embodiments of the present invention, selected products may be within multiple categories, and more often, within multiple subcategories. For example, a type of adhesive such as wood glue may be within the adhesive category, and within the glue subcategory and the wood glue subcategory. Accordingly, in accordance with various embodiments of the present invention, product use categories and subcategories for a company's products may be cross-referenced within a company's PHM database to indicate that a particular product or particular products are needed for use in multiple categories and/or subcategories.

Thus, the present invention, in accordance with various embodiments, allows for companies to reduce the overall number of products, especially potentially hazardous products, within its inventory. Additionally, redundant products may be reduced. Lower costs, lower toxicity levels and less harmful effects on the environment may be realized. Better control of companies' product inventories may also be achieved. Consolidation of products from fewer suppliers may also be realized.

While the present invention has been described with respect to hazardous materials and their toxicity levels, cost and suppliers, those skilled in the art will realize that management and procurement of other types of materials may benefit from various embodiments of the present invention. Those skilled in the art will also realize that other criteria may be applied to various embodiments of the present invention for both hazardous materials and other types of materials.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

What is claimed is:

1. A method comprising:
providing a plurality of product categories for potentially hazardous products, the categories based upon use;
assigning a product a first value based upon a first criterion;
assigning the product a second value based upon a second criterion; and
correlating the first and second values for a plurality of products within at least one selected product category.

2. The method of claim 1, wherein the assigning a first value comprises determining a value based upon at least one of toxicity or environmental effect of the product.

3. The method of claim 2, wherein the assigning a first value comprises determining a value based upon at least one of toxicity or environmental effect of the product based upon multiple data sources.

4. The method of claim 1, wherein the assigning a second value comprises determining a value based upon one of price of the product, toxicity of the product or environmental effect of the product.

5. The method of claim 1, further comprising displaying results of the correlating.

6. The method of claim 5, wherein the assigning a first value comprises determining a value based upon at least one of toxicity or environmental effect of the product, the assigning a second value comprises determining a value based upon at least one of price of the product, toxicity of the product or environmental effect of the product, and the correlating and displaying comprises preparing and displaying a scattergram based upon the first and second values.

7. The method of claim 1, further comprising printing results of the correlating.

8. The method of claim 1, further comprising selecting at least one product based upon the correlating.

9. The method of claim 8, wherein the selecting comprises selecting multiple products within the selected product category.

10. The method of claim 1, further comprising correlating the first and second values for a plurality of products within multiple product categories and selecting at least one product from each of the multiple product categories based upon the correlating.

11. The method of claim 10, wherein the selecting at least one product from each of multiple product categories comprises selecting each of the at least one products from the same supplier.

12. The method of claim 10, further comprising cross-referencing product categories that include at least one common selected product.

13. The method of claim 10, further comprising preparing a list of selected products arranged by product category.

14. The method of claim 13, further comprising validating the list of selected products based upon at least one factor.

15. The method of claim 14, wherein the validating comprises determining a level of effectiveness for each product.

16. An apparatus comprising:
a storage medium including stored therein a plurality of instructions adapted to correlate a plurality of product values for potentially hazardous products within a product category that is defined by product use, the correlation being based upon at least two values assigned to each product; and
one or more processors operatively coupled to the storage medium to execute the instructions.

17. The apparatus of claim 16, wherein one of the at least two values is based upon at least one of toxicity or environmental effect of a product.

18. The apparatus of claim 16, wherein one of the at least two values is based upon at least one of price of a product, toxicity of a product or environmental effect of a product.

19. The apparatus of claim 16, further comprising a display operatively coupled to the one or more processors and wherein the instructions are further adapted to cause the display to display results of the correlating.

20. The apparatus of claim 19, wherein instructions are adapted to display the results as a scattergram.

21. The apparatus of claim 20, further comprising a printer operatively coupled to the one or more processors, and wherein the instructions are further adapted to cause the printer to print results of the correlating.

22. The apparatus of claim 16, wherein the instructions are further adapted to select at least one product within the product category based upon the correlating.

23. An article of manufacture comprising:
a storage medium; and
either a plurality of product categories of potentially hazardous products, a plurality of instructions, or both stored therein;
wherein the plurality of instructions are adapted to cause one or more processors to perform a plurality of operations, the plurality of operations comprising:
assigning a product a first value based upon a first criterion;
assigning the product a second value based upon a second criterion; and
correlating the first and second values for a plurality of products within at least one selected product category.

24. The article of manufacture of claim 23, wherein the assigning a first value comprises determining a value based upon at least one of toxicity or environmental effect of the product.

25. The article of manufacture of claim 24, wherein the assigning a first value comprises determining a value based upon at least one of toxicity or environmental effect of the product based upon multiple data sources.

26. The article of manufacture of claim 23, wherein the assigning a second value comprises determining a value based upon at least one of price of the product, toxicity of the product or environmental effect of the product.

27. The article of manufacture of claim 23, wherein the plurality of operations further comprise displaying, on a display, results of the correlating.

28. The article of manufacture of claim 27, wherein the assigning a first value comprises determining a value based upon at least one of toxicity or environmental effect of the product, the assigning a second value comprises determining a value based upon at least one of price of the product toxicity of the product or environmental effect of the product, and the correlating and displaying comprises preparing and displaying a scattergram based upon the first and second values.
